(19) United States
(12) Patent Application Publication
(10) Pub. No.: US 2011/0130885 A1
(43) Pub. Date: Jun. 2, 2011

(54) METHOD AND SYSTEM FOR MANAGING THE PROVISIONING OF ENERGY TO OR FROM A MOBILE ENERGY STORAGE DEVICE

(76) Inventors: DONALD J. BOWEN, Madison, NJ (US); Patricia E. Bowen, Madison, NJ (US); Paul D. Heitmann, Madison, NJ (US); Robert R. Miller, II, Convent Station, NJ (US)

(21) Appl. No.: 12/628,302

(22) Filed: Dec. 1, 2009

(51) Int. Cl. G06F 1/28

(52) U.S. Cl. 700/291; 700/295

(57) ABSTRACT

A method and system for managing the provisioning of energy to or from mobile energy storage devices are disclosed. For example, the method receives a current intended energy use for a mobile energy storage device associated with a user, and analyzes whether the current intended energy use is achievable based upon a current energy state of the mobile energy storage device. The method then provides a recommendation to an endpoint device associated with the user in response to the current intended energy use.

The present disclosure relates generally to mobile energy storage devices, and more particularly, to a method and system for managing the provisioning of energy to or from the mobile energy storage devices.

### BACKGROUND

Mobile energy storage devices, including electric vehicles with batteries (broadly mobile energy storage units), such as plug-in hybrids, are just beginning to emerge as alternative to conventional vehicles. As an example, electric vehicles will require a whole new charging infrastructure to replace the present resources for conventional vehicles, such as gas stations, and it will be some time before such infrastructure matures. Additionally, the charging of electric vehicles will require planning, foresight and careful attention that are unnecessary with respect to fueling conventional vehicles. For example, a conventional fossil fuel driven vehicle can be fueled at a service station in a matter of several minutes. The inconvenience of having to make an unscheduled stop to fuel the vehicle in this manner is insubstantial. However, fully charging a near empty electric vehicle may require several hours to complete. This poses a serious inconvenience for the vehicle owner and creates logistical challenges to electric energy providers (e.g., a service station) because a limited number of charging stations (akin to a pumping station) may be occupied for a substantial period of time by electric vehicles. Moreover, the cost to deliver electric energy may vary significantly depending on the time of day, thereby creating opportunities and pitfalls to an electric vehicle owner. In other words, an electric vehicle owner may save or lose money depending on when he chooses to charge the electric vehicle.

### SUMMARY

In one embodiment, the present disclosure discloses a method and system for managing the provisioning of energy to or from mobile energy storage devices. For example, the method receives a current intended energy use for a mobile energy storage device associated with a user, and analyzes whether the current intended energy use is achievable based upon a current energy state of the mobile energy storage device. The method then provides a recommendation to an endpoint device associated with the user in response to the current intended energy use.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates a flowchart of a method for managing the provisioning of energy to or from a mobile energy storage device;

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, a computer readable medium and a system for managing the provisioning of energy to or from a mobile energy storage device. Although the present disclosure is discussed below in the context of Internet Protocol (IP) Multimedia Subsystem (IMS) networks, the present disclosure is not so limited. Namely, the present disclosure can be applied to packet networks in general, e.g., Internet Protocol (IP) networks, Service over Internet Protocol (SoIP) networks, the Internet and the like.

Mobile energy storage units (such as those that power electric vehicles) will require recharging as vehicles that utilize them travel from place to place. This raises new challenges, such as 1) determining where (and at what times and rates) facilities are available for connecting to an energy source; 2) prioritizing access as required (e.g., by predicted need, time-of-day, using price or quantity limits); 3) billing for the energy delivered (e.g., based on time-of-day, or rate of charge); 4) when appropriate (e.g., during a peak demand situation) determining whether the vehicle is capable of selling energy (e.g., providing energy back to the utility company or electric grid) instead of receiving energy, and whether this is allowed and makes sense for the user based on predictions of his upcoming travel needs and preferences. In addition, in the case of electric cars and plug-in hybrids, strangers may wish to swap electric charge between their vehicles (e.g., a direct connection between the two vehicles via an electric cable), thereby creating a “mobile grid.”

To address these issues and others, embodiments of the present disclosure utilize communication and data processing technology to enhance the efficiency and ease of energy delivery and consumption in a variety of novel methods. In particular, databases, location information, data mining, communication and billing services, and other informational data can be shared via an integrated network and the gathered data can be used to efficiently calculate optimal energy transaction scenarios. For example, charging an electric vehicle away from home may be facilitated by a method of automatically identifying both the vehicle battery that is receiving energy and the party (e.g., registered owner) responsible for paying the electric bill, and performing the necessary financial transactions. Alternatively, an amply charged vehicle battery may connected to a “visitor” charging station and may actually provide energy back into the electric grid during times of peak demand, as long as the location and predicted driving behaviors of the operator of the vehicle (e.g., derived from network information and algorithms analyzing typical use patterns) indicate that this is prudent. In such instances, the cost of the metered energy contributed by the vehicle battery would be credited to the registered owner.

As mentioned above, the present disclosure relates to managing the provisioning of energy to or from one or more mobile energy consuming and/or storage devices. The mobile energy consuming devices in one embodiment comprise electric vehicles. For ease of reference, the present disclosure will now primarily be described in connection with embodiments relating to electric vehicles as the mobile energy consuming devices.

Electric vehicles (including plug-in hybrids) are just beginning to emerge as alternatives to conventional fossil fuel based vehicles and these electric vehicles require a whole new charging infrastructure to replace gas stations. In addition, it will be some time before such a new infrastructure matures. In accordance with embodiments of the present disclosure, the mining of real-time and historical information enhances the efficiency and ease of using electric vehicles. For example, in one embodiment such information may broadly comprise vehicle location, user location, driving patterns, user itineraries (e.g., via user calendar information), traffic congestion, weather, energy source locations, source capacity, source cost, peak-demand events, openness to “sink” energy, alternative mobile sources (e.g., other electric cars), etc.

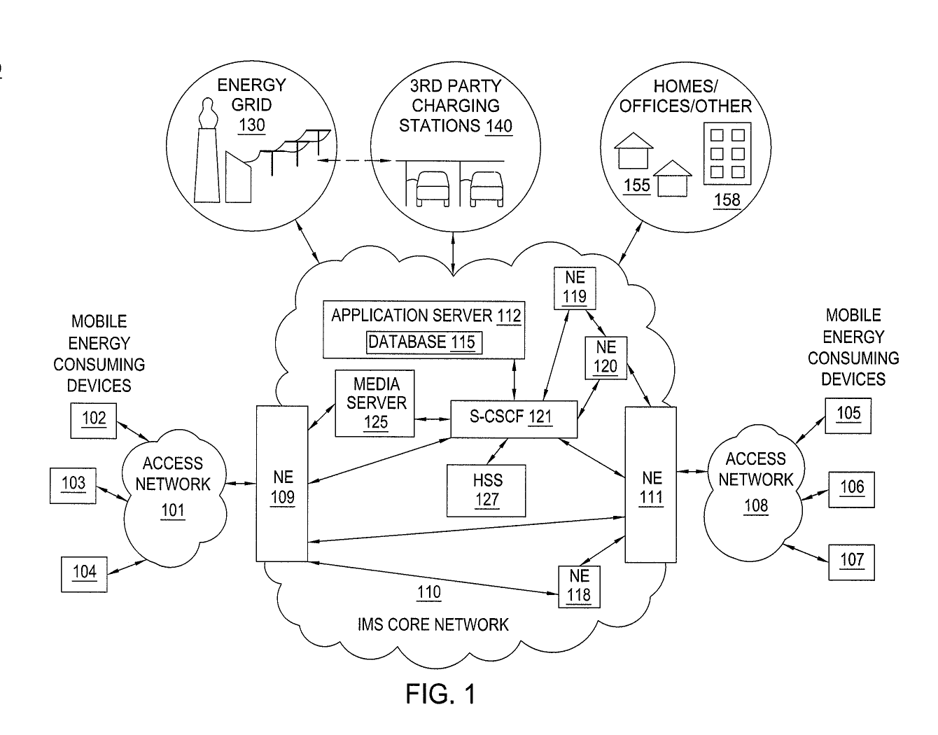

To better understand the present disclosure, FIG. 1 illustrates an example network 100, e.g., an Internet Protocol (IP) Multimedia Subsystem network related to the present disclosure. An IP network is broadly defined as a network that uses Internet Protocol to exchange data packets. It should be noted that the network 100 is only provided as an illustrative network. Any networks that can support the methods as further discussed below are contemplated by the present disclosure.

In one embodiment, the network 100 may comprise a plurality of electric vehicles 102-104 configured for communication with the core IMS network 110 (e.g., an IP based core backbone network supported by a service provider) via an access network 101. Similarly, a plurality of electric vehicles 105-107 (i.e., the mobile energy consuming devices/mobile energy storing devices) are configured for communication with the IMS core packet network 110 via an access network 108. The network elements 109 and 111 may serve as gateway servers or edge routers for the network 110.

The access networks 101 and 108 serve as a conduit to establish a connection between the electric vehicles 102-107 and the Network Elements (NEs) 109 and 111 of the IMS core network 110. The access networks 101 and 108 may each comprise a Digital Subscriber Line (DSL) network, a broadband cable access network, a Local Area Network (LAN), a Wireless Access Network (WAN), a 3^{rd} party network, a cellular network and the like. The access networks 101 and 108 may be either directly connected to NEs 109 and 111 of the IMS core network 110, or indirectly through another network.

Some NEs (e.g., NEs 109 and 111) reside at the edge of the IMS core infrastructure and interface with customer endpoints over various types of access networks. An NE that resides at the edge of a core infrastructure is typically implemented as an edge router, a media gateway, a proxy server, a border element, a firewall, a switch, and the like. An NE may also reside within the network (e.g., NEs 118-120) and may be used as a SIP server, a core router, or like device.

The IMS core network 110 also comprises a Home Subscriber Server (HSS) 127, a Serving—Call Session Control Function (S-CSCF) 121, a Media Server 125, and an Application Server 112 that contains a database 115. An HSS 127 refers to a network element residing in the control plane of the IMS network that acts as a central repository of all customer specific authorizations, service profiles, preferences, etc.

The S-CSCF 121 resides within the IMS core infrastructure and is connected to various network elements (e.g., NEs 109 and 111) using the Session Initiation Protocol (SIP) over the underlying IMS based core backbone network 110. The S-CSCF 121 may be implemented to register users and to provide various services (e.g. VoIP services). The S-CSCF interacts with the appropriate VoIP/SoIP service related applications servers (e.g., 112) when necessary. The S-CSCF 121 performs routing and maintains session timers. The S-CSCF may also interrogate an HSS to retrieve authorization, service information, user profiles, etc. In order to complete a call that requires certain service specific features, the S-CSCF may need to interact with various application servers (e.g. various VoIP servers).

The Media Server (MS) 125 is a special server that typically handles and terminates media streams to provide services such as announcements, bridges, and Interactive Voice Response (IVR) messages for VoIP service applications. The media server also interacts with customers for media session management to accomplish tasks such as process requests.

The application server 112 may comprise any server or computer that is well known in the art, and the database 115 may be any type of electronic collection of data that is also well known in the art. In one embodiment, the database 115 may store information that is used by the application server 112 to manage the provisioning of energy to or from electric vehicles 102-107, as will be discussed in further detail below. It should be noted that the communication system 100 may be expanded by including additional mobile energy consuming devices, access networks, network elements, application servers, etc. without altering the scope of the present disclosure.

In the embodiment depicted in FIG. 1, the core IMS network 110 is in communication with various external energy repositories such as the energy grid 130, third party charging stations 140, and other sources such as homes 155 and offices 158. As referred to herein, the energy grid 130 may comprise one or more electric utility grids (i.e., electricity transmission networks), such as maintained by one or more utility companies. Thus, although the energy grid 130 is referred to herein in the singular form, it should be understood that the energy grid 130 may comprise one or more sub-grids. In addition, although the energy grid 130 is depicted in FIG. 1 as being coupled to the IMS core network 110 via a single interface, it should be understood that the energy grid 130 may have numerous connections with the IMS core network 110, which may traverse various geographic locations, and the connections may alternatively include one or more access networks (not shown).

In various embodiments, one or more energy repositories (broadly energy sources) in communication with the IMS core network may comprise third party charging stations 140. For example, a business may operate a charging station in a manner similar to conventional gas stations, but provide electric charging to electric powered vehicles. While, a third party charging station 140 may not generate its own energy, it may procure wholesale quantities of energy (e.g., from an energy utility company), and resell the energy to owners of electric vehicles. For example, a third party charging station 140 may obtain energy from the energy grid 130 at a discount rate and resell the energy to one or more of the electric vehicles 102-107 at a higher rate. However, it should be noted that charging station could in fact be owned and operated by an utility company that also provides electricity to the user's home or business.

In addition, the third party charging stations 140 may interface with the IMS core network 110 in various ways. For example, multiple third party charging stations 140 may be owned by a single entity which may maintain its own IP network with a central database which may track and maintain data on various resources at the various charging station locations controlled by the entity. Thus, there may be a single point-of-contact between the IMS core network 110 and the single entity for communicating information relating the various charging station resources (e.g., the number of available spaces or slots for charging, the charging rates, the type of charging (fast charge or slow charge), and the like). Alternatively, each third party charging station 140 may interface individually with the IMS core network 110. Numerous additional interface architectures may be implemented, all within the spirit and scope of the embodiments disclosed herein. In addition, regardless of the manner of interfacing between the IMS core network 110 and third party charging stations 140, the connection(s) may comprise one or more access networks (not shown) and may comprise one or more of any of a wireless, fiber-optical or other physical link.

In various embodiments, other energy sources of energy in addition to the energy grid 130 and third party charging stations 140 may be operatively coupled to the IMS core network 110. For example, another source of energy may simply be an electrical outlet in a home 155 or office 158. Accordingly, in various embodiments, the home 155 or office 158 may comprise a “smart home” or “smart office” each having capability for interfacing with an IP network, such as a local personal computer, a network interface card, a wireless interface card and a connection to a local access network, such as via an Internet service provider (ISP) network. For example, a home 155 serving as an energy source as described herein would be the home of the owner of an electric vehicle 102-107. However, the home 155 could just as easily comprise that of a friend or a neighbor. Similarly, although the office 158 would typically comprise the place where the owner of an electric vehicle 102-107 actually works, the office 158 may comprise any other building with an interface for sourcing energy to, and receiving energy from, an electric vehicle 102-107. For example, office 158 may comprise another office near where the owner of an electric vehicle 102-107 works. Although not depicted in FIG. 1 for clarity, it should be understood that numerous other homes and offices may be in communication with the IMS core network 110. In addition, the connections between the IMS core network 110 and the office 158 and home 155 may be similar to the connections between the IMS core network 110 and the energy grid 130 and/or third party charging stations 140 (e.g., via one or more access networks, etc.).

The above IP network is described to only provide an illustrative environment in which packets for voice, data and multimedia services are transmitted on networks. As such, the current disclosure discloses a method and system for managing the provisioning of energy to or from mobile energy storage devices in an exemplary communication network (e.g., an IMS network) illustrated in FIG. 1 and as described above.

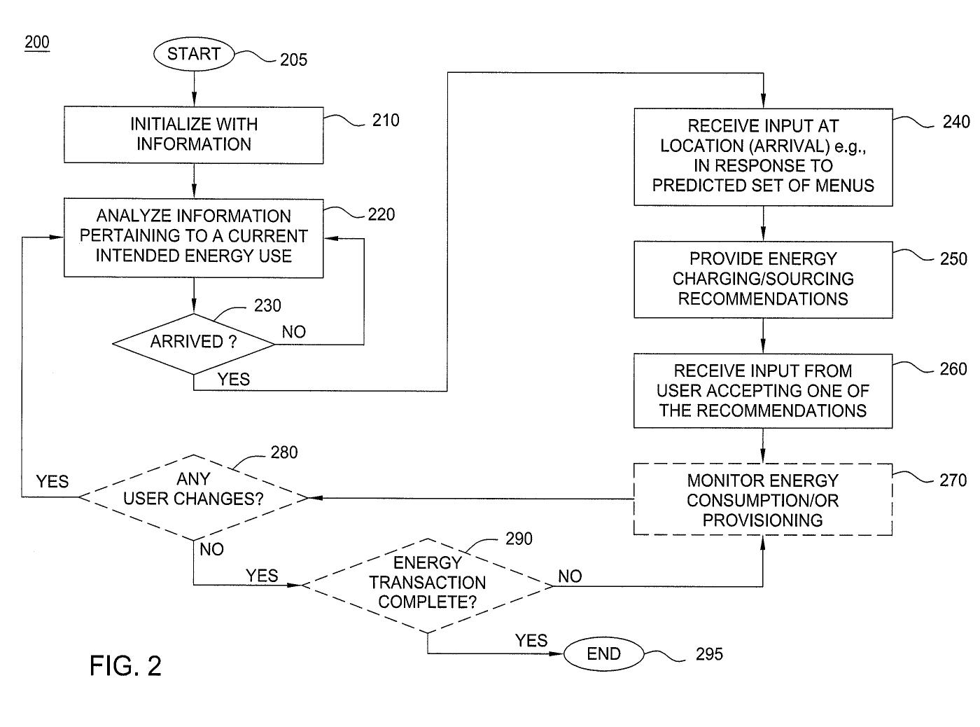

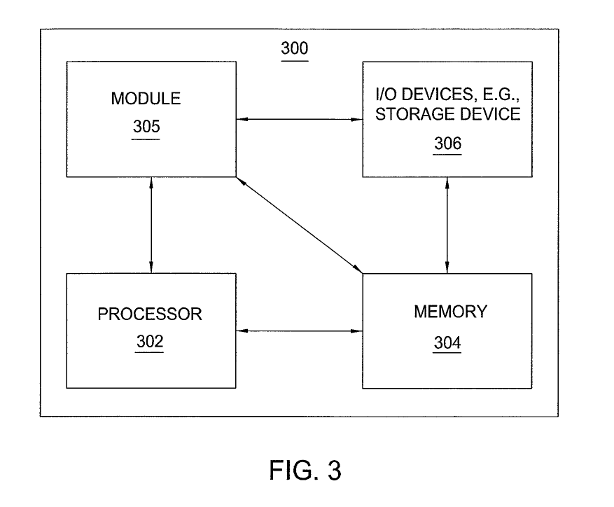

FIG. 2 illustrates a flowchart of a method 200 for managing the provisioning of energy to or from mobile energy storage devices in an IMS network. In one embodiment, one or more steps of the method 200 can be implemented by the application server 112 or a general purpose computer having a processor, a memory and input/output devices as illustrated below in FIG. 3. Alternatively, the method 200 may be implemented by the S-CSCF in coordination with the application server 112 and/or the database 115, or in any one of the network elements, such as NEs 109, 111, 118, 119 or 120.

The method 200 begins at step 205. At step 210, the method 200 initializes with information. For example, a device performing the method, such as an application server or general purpose computer may receive data/information from various sources which may comprise without limitation the devices depicted in FIG. 1, e.g., an energy grid 130, third party charging stations 140, homes 155, office buildings 158, and electric vehicles 102-107. Such information may also comprise user specific information which may be received via one or more user endpoint devices, e.g., a personal computer at the user's home or office, wireless PDA, a mobile phone, a smart phone, or an interface or computer provided by the user's electric vehicle. Thus, although electric vehicles 102-107 in FIG. 1 are depicted as being in communication with IMS core network 110 via access networks 101 or 108, it should be understood that an electric vehicle as embodied herein may have no connectivity means of its own. Rather, in certain cases some or all relevant information regarding the electric vehicle may still be conveyed to the IMS core network 110 indirectly such as through user endpoint devices and/or user responses to IVR queries via the user endpoint devices.

The embodiments herein describe several broad categories of information that are gathered by the method 200. For example, such information may comprise current or historical: (1) location information, (2) calendar or scheduling information, (3) energy need information, and (4) availability of energy source information and cost of energy information. The first three categories may be information that is specific to a particular user. For example, the user specific information (broadly user information) may comprise various data including the user's calendar data, which may indicate the upcoming scheduled events (e.g., for the current day or week), current location information, current intended destination information, historical data, such as the user's typical weekday, weekend, time-of year or other routine, and user preferences, such as cost preferences, energy charging time preferences, charging type preferences (e.g., trickle charge versus fast charge) or energy provider preferences (e.g., the user is a member of a third party energy provider's rewards program, or the user wants to be billed by the utility company serving the user so that the user receives one consolidated bill on electric use). For example, the user may maintain calendar data in an application, e.g., provided by third party software vendors, or a calendar application maintained by a network service provider, which the method obtains as part of the information gathering step 210. In one embodiment, the user specific information may include information relating to other family members, such as spouse and children's calendar information or information relating to the availability of additional electric vehicles (e.g., a second family car). Advantageously, providing user calendar information, both current and historical, gives the method greater opportunity to accurately schedule/predict charging scenarios.

The user specific information may also include the user's energy need information. The energy need information may include current location and intended destination information, as well as information pertaining to a user's electric vehicle. For example, electric vehicle related information may be obtained from a processing source (e.g., a vehicle processor or computer) residing within or integrated with the electric vehicle, and may track such things as current velocity, current energy state of vehicle batteries, current location (e.g., GPS information), rate of energy consumption and utilization, or acceleration data. Alternatively, as mentioned above, the vehicle related information may be manually entered by a user. In some embodiments, the method may interface with a user such as through interactive voice response (IVR) prompts via various user communication devices. For example, upon the method detecting that a user has entered a vehicle and will likely begin driving shortly, the method may query the user whether the user intends to drive directly home, as the method anticipates, or will make any unscheduled stops. The method may then make various calculations, depending upon the user response. For example, the energy need information may be derived from an aggregation of the user's calendar data, electric vehicle data and responses to queries from the method (e.g., user responses to IVR prompts).

Also in step 210, the method gathers information on energy source availability and/or cost (broadly energy repository information). For example, the method gathers information from the energy grid 130 and third party charging stations 140 on energy availability. As mentioned above, the energy grid 130 and third party charging stations 150 may be respectively coupled to the IMS core network 110 via a single interface or via numerous connections with the IMS core network 110, which may traverse various geographic locations. The connections may alternatively include one or more access networks (not shown). The energy grid 130 may be maintained by an energy utility company for example, which may maintain a central or distributed information management system (e.g., via one or more LANs, a WAN, one or more servers, databases, etc.). The method obtains information relating to the energy grid 130 from the energy utility's information management system. Such energy repository information may broadly comprise without limitation, the location and availability of energy, current and future energy prices, available types of energy transfer (broadly charging type information e.g., slow trickle charge, fast charge, etc.), whether the utility is accepting energy deposits (e.g., a user selling energy back to the grid) and at what prices, how the user will be billed (broadly billing information e.g., credit card, or via the utility company currently serving the user, and the like). The source energy availability information may include location specific pricing information, types of energy available (fast charge, slow trickle, etc.), and quantities of energy available. In addition, the source energy availability information may also include information on opportunities to “sink” energy, that is, to buy-back energy from the users of electric vehicles with extra available charge. For example, a third party charging station may be short on available charge and may therefore desire to purchase additional charge from users with electric vehicles having charge to spare. The method may gather such information from third party charging stations 140, the energy grid 130, or even from other users who may wish to find opportunities to trade charge directly, vehicle-to-vehicle for a fee.

In one embodiment, the method queries the information sources to provide the requested information. In another embodiment, the sources of information provide the data/information automatically, e.g., at predefined time intervals. The predefined time intervals may be a network- or user-configurable parameter and may be particularized to different device types and even to individual devices. Additionally, the information sources may be configured to provide information directly or indirectly, such as by a user manually inputting the information via a personal computer, wireless PDA, etc. and transmitting the information as necessary or desired. For example, as mentioned above, the method may prompt a user for responses to various queries, such as via an exchange with an IVR system.

In step 220, the method analyzes information pertaining to a current intended energy use. For example, an owner upon entering an electric vehicle may inform the computer on the vehicle of the current intended energy use, e.g., intended destination (e.g., a work location) for the current use of the electric vehicle. In one embodiment, the current intended energy use is then provided to the application server 112 by the computer on the vehicle. Alternatively, the owner may simply activate an application of a communication device (e.g., a smart phone) to declare the current intended energy use, e.g., that he or she is now heading to work. In turn, the current intended energy use is received by the application server 112 via the smart phone.

For example, the current intended energy use may include information pertaining to the current location, intended destination and current energy state of an electric vehicle. At step 220, the method analyzes the information obtained in steps 210 and 220 to determine whether the user's electric vehicle has enough electric charge (i.e., energy) to complete the current intended energy use, e.g., within a reasonable margin of safety/error. If the method determines that the user's electric vehicle has enough charge to safely reach the intended destination, then the method communicates to the user (broadly a recommendation or a notification pertaining to a likelihood of success) that the current intended energy use is recommended. For example, the method may transmit a message to one or more user devices, or an interface integrated in the electric vehicle to notify the user that the trip may be safely attempted with the current energy state of the electric vehicle. Alternatively, if the method determines that the user's electric vehicle does not have enough charge to safely reach the intended destination, then the method communicates to the user that the current intended energy use will require an additional action, e.g., a detour to a charging location to charge the electric vehicle. For example, the method may transmit a message to one or more user devices, or an interface integrated in the electric vehicle to notify the user that the trip may not be safely attempted with the current energy state of an electric vehicle. The message may include a recommendation (broadly proposed energy transactions) as to one or more charging stations along the route to the intended destination. The message may include the driving directions to the charging station, the cost per unit of energy charged by the charging stations, the minimum amount of charge time that is needed at the charging station to reach the intended destination, and so on.

It should be noted that step 220 can be a step that is repetitively executed. For example, an electric vehicle, such as any of electric vehicles 102-107 depicted in FIG. 1, may periodically transmit information relating to its current location, bearing, velocity, quantity of available energy, current rate of energy consumption, and other data. The current rate of energy consumption information may comprise an instantaneous or average velocity over certain time periods which may be configurable parameters.

At step 230, the method determines whether the user and the electric vehicle have arrived at the intended destination. If not, the method returns to step 220 to receive current information, e.g., pertaining to energy use or current location of the vehicle, e.g., the computer in the vehicle or the user's smart phone may periodically provide current information to the application server 112. In this manner, the method is able to continuously monitor whether the user has deviated from the intended course.

For example, if the user obtains notification from the method that a particular trip may be safely completed, but the user decides instead to drive to another intermediate location before continuing to the intended destination, and if such “unannounced” detour is detected, then the method can monitor whether the trip may be trending towards becoming a non-recommended trip. In addition, in one embodiment upon detecting a deviation from the intended course, the method may query the user as to his alternative plans. For example, if the user informs an intermediate destination to the method and the method calculates that the full trip will not be possible with the current energy state of an electric vehicle, the method can notify the user and begin calculating alternatives. For example, the method may identify possible charging locations along the new route and provide one or more choices to the user as to when and where sufficient charge can be acquired in order to complete the trip.

If the method determines that the user has arrived at the intended destination at step 230, the method proceeds to step 240.

At step 240, the method receives confirmation of the arrival of the user at the intended destination, e.g., via an IVR query and response. For example, the user may actively inform the application server via the computer in the vehicle or via the smart phone that he or she has arrived at the intended destination and that the current intended energy use has come to an end. For example, the application server can automatically (e.g., based on GPS coordinates) send a short message, “Arrived at intended destination? Press “1” for yes, and “0” for no” to the user, where the user can reply accordingly and the like.

In one embodiment, the method receives additional input as to the next intended energy use. For example, the method may query the user via a set of predictive menus about future travel plans and scheduling. For example, a user may just have arrived at home after a day at work on a Tuesday. In addition, the method may have gathered calendar data and historical data at step 210 which indicates that the user intends to travel directly to work the next morning and that the user typically travels directly to work on weekday mornings. Therefore, the method may query the user whether the user intends to travel directly to work in the morning as usual. In addition, the method may query whether the user intends to do any unscheduled errands during the next day's evening that may require the use of the vehicle. If the user responses indicate that there are no deviations from the predicted schedule, the method may determine that a charging should be performed in the user's home garage for a predetermined amount of time, e.g., after 11:00 pm to get the best charging rate, for only four hours to achieve the predicted energy use for tomorrow's itinerary, and so on. For example, the recommendation must be sufficient to provide adequate charge replenishment to complete a round trip to and from work the next day, while taking advantage of less expensive electric energy rates overnight. Alternatively, the method may, based upon information obtained from the user's office building, determine that a cost-efficient and convenient charging could be completed in the office garage the next day between 9:30 a.m. and 4:00 p.m. while the user is in the office. If that is the case, the method may adjust the recommendation such that the user may only charge the vehicle at home up to the point that will allow the user to arrive at the office garage the next day to take advantage of the lower charging rate, and so on.

In step 250, the method may provide one or more alternative charging scenario recommendations (broadly one or more proposed energy transactions) to the user. For instance, in the example given above, the method may determine that an overnight charging at home or charging at the office parking garage during work the next day are equally viable alternatives for the user. The method may provide these two alternative recommendations to an endpoint device (e.g., a smart phone, an interface or computer in the vehicle, and the like) associated with the user and await a response from the user selecting one of the two. For example, the office garage may have limited charging resources which must be scheduled in advance and if the user does not select this option in a timely manner, it may become unavailable due to another user claiming the use of the charging resource during the same time slot.

At step 260, the method receives a response from the user selecting or rejecting a charging/sourcing recommendation. If a user rejects all of the recommended charging/sourcing scenarios, the method may alternatively return to step 250 to calculate additional possible charging scenarios for the user, or the method may prompt the user to manually schedule an intended charging, giving the location, time and/or amount of charge to be obtained. If the user selects a recommended charging scenario or manually provides an intended charging scenario that will require the use of a particular resource (e.g., one of the possible energy sources discussed above), the method may, in some embodiments, proceed to schedule the resource. For example, if the method offered the user a choice of charging at a third party charging station near the user's office during the workday the next day, the method may transmit a confirmation to the third party charging station reserving a charging station for the required time so that the user's charging need will be assured.

Alternatively, if the method recommends selling energy back to the energy grid at step 250 and the user accepts the recommendation at step 260, then the method may also transmit a confirmation to the energy grid 130 noting the location and duration where the user will hook-up with the energy grid 130 to provision the charge. For example, if a user arrives at the office and there is insufficient energy that is reserved for charging electric vehicles, e.g., a very high electric energy use day due to extremely hot weather, roving brown-outs and the like, then a user may opt to provide a portion of the stored energy in the vehicle to be provided back to the energy grid or to another user at the office location.

At optional step 270, the method monitors the consumption or provisioning of energy. For example, the method may monitor both ends of a scheduled energy transaction, obtaining data on the current state of an electric vehicle and obtaining information on the quantity of energy transferred to or from the energy grid. For example, if the car is charging at home, the computer in the car may periodically send a message to the application server 112 indicating the current charge state of the vehicle. Optionally, in turn the application server may send a notification to the user (e.g., an email, an SMS message, and the like) or a notification to the computer in the vehicle that the charging has reached a level sufficient to achieve the next day's itinerary. This will allow the user or the computer in the vehicle to terminate the charging process, which may extend battery life. Step 270 is deemed optional because the current charge state of the vehicle can in fact be provided at step 220 when the user operates the vehicle in the next instance.

In optional step 280, the method may detect if there are any user changes to the ongoing energy transaction. In other words, the method may monitor for user changes that may affect an ongoing scheduled energy transaction. For example, if the method is notified of a change in user status, e.g., via a notification message from the user, the method loops back to step 220 and receives further and additional information related to current energy use. For example, the user may have left his electric vehicle at a charging station in his office parking lot in the morning and has been working in the office. At noon, the user may receive a call from his spouse indicating a change in evening plans. For example, the user may now need to pick up a child after school at 3:30 PM. If the scheduled charging was supposed to be completed at 4:00 PM, a change will need to be made to the energy transaction. For example, the energy transaction may simply be rescheduled to terminate at 3:00 PM and the electric vehicle will be only partially charged instead of fully charged.

Alternatively, if the originally scheduled energy transaction involved a less expensive slow-trickle charge, the method may notify the charging station and the electric vehicle of the need to change to a fast charge at some point during the energy transaction. In this manner, the combination of slow trickle charging and fast charging may be combined to fully charge the electric vehicle's batteries before the 3:00 PM departure time. If a user change is detected, the method returns to step 220 to gather updated information, including new user-specific information such as a revised afternoon schedule. If no user change is detected in connection with the ongoing energy transaction, the method proceeds to step 290.

In optional step 290, the method determines if the energy transaction is successfully completed. If the query is negatively answered, then the method returns to step 270 to continue monitoring the energy transaction. If the query is positively answered, then the method ends at step 295. It should be noted that the method 200 may begin anew at step 220 as the user returns to the vehicle some time after the end of the previous iteration of the method at step 295. In this manner, the method may be performed repeatedly for a user during the life-cycle of the electric vehicle.

It should be noted that although not specifically specified, one or more steps of method 200 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 2 that recite a determining operation or involve a decision, do not necessarily require that both branches of the determining operation be practiced. In other words, one of the branches of the determining operation can be deemed as an optional step.

FIG. 3 depicts a high-level block diagram of a general-purpose computer suitable for use in performing the functions described herein. As depicted in FIG. 3, the system 300 comprises a processor element 302 (e.g., a CPU), a memory 304, e.g., random access memory (RAM) and/or read only memory (ROM), a module 305 for managing the provisioning of energy to or from a mobile energy consuming device, and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents. In one embodiment, the present module or process 405 for creating a social network map using non-voice communications can be loaded into memory 304 and executed by processor 302 to implement the functions as discussed above. As such, the present module 305 for managing the provisioning of energy to or from a mobile energy consuming device (including associated data structures) of the present disclosure can be stored on a computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for managing a provisioning of energy via a communication network, comprising:
receiving a current intended energy use for a mobile energy storage device associated with a user;
analyzing whether said current intended energy use is achievable based upon a current energy state of said mobile energy storage device; and
providing a recommendation to an endpoint device associated with said user in response to said current intended energy use.

2. The method of claim 1, wherein said current intended energy use comprises a current location of said mobile energy storage device and an intended destination.

3. The method of claim 1, wherein the communication network comprises an Internet Protocol (IP) Multimedia Subsystem IMS network.

4. The method of claim 1, wherein said analyzing is performed by an application server deployed in said communication network.

5. The method of claim 1, wherein said analyzing applies user information comprising at least one of: a user schedule, calendar data, historical data, family member data, charging type information, charging rate information, or billing information.

6. The method of claim 5, wherein said user information is provided automatically by the mobile energy storage device.

7. The method of claim 5, wherein said user information is provided by the user.

8. The method of claim 1, wherein said analyzing applies energy repository information comprising at least one of: an energy cost, a charging location, charging type information, billing information, an opportunity to sell charge back to an energy grid, or an opportunity to sell charge to another user.

9. The method of claim 1, wherein said recommendation comprises a recommendation to obtain energy from an energy source comprising at least one of: an energy utility, a third party charging station, a home, or an office building.

10. The method of claim 1, wherein said recommendation comprises one or more proposed energy transactions between the mobile energy storage device and at least one energy source.

11. The method of claim 10, further comprising:
receiving a selection from the user in response to the one or more proposed energy transactions.

12. The method of claim 1, further comprising:
monitoring said mobile energy storage device for a completion of said current intended energy use.

13. The method of claim 12, further comprising:
detecting said completion of said current intended energy use; and
sending a second recommendation that comprises one or more proposed energy transactions between the mobile energy storage device and at least one energy source.

14. A computer-readable storage medium having stored thereon a plurality of instructions, the plurality of instructions including instructions which, when executed by a processor, cause the processor to perform steps of a method for managing a provisioning of energy via a communication network, comprising:
receiving a current intended energy use for a mobile energy storage device associated with a user;
analyzing whether said current intended energy use is achievable based upon a current energy state of said mobile energy storage device; and
providing a recommendation to an endpoint device associated with said user in response to said current intended energy use.

15. The computer-readable storage medium of claim 14, wherein said current intended energy use comprises a current location of said mobile energy storage device and an intended destination.

16. The computer-readable storage medium of claim 14, wherein said analyzing is performed by an application server deployed in said communication network.

17. The computer-readable storage medium of claim 14, wherein said analyzing applies user information comprising at least one of: a user schedule, calendar data, historical data, family member data, charging type information, charging rate information, or billing information.

18. The computer-readable storage medium of claim 17, wherein said user information is provided automatically by the mobile energy storage device.

19. The computer-readable storage medium of claim 14,
wherein said analyzing applies energy repository information comprising at least one of: an energy cost, a charging location, charging type information, billing information, an opportunity to sell charge back to an energy grid, or an opportunity to sell charge to another user; and
wherein said recommendation comprises a recommendation to obtain energy from an energy source comprising at least one of: an energy utility, a third party charging station, a home, or an office building.

20. An apparatus for managing a provisioning of energy via a communication network, comprising:
means for receiving a current intended energy use for a mobile energy storage device associated with a user;
means for analyzing whether said current intended energy use is achievable based upon a current energy state of said mobile energy storage device; and
means for providing a recommendation to an endpoint device associated with said user in response to said current intended energy use.
